(19) United States
(12) Patent Application Publication
(10) Pub. No.: US 2004/0065179 A1
(43) Pub. Date: Apr. 8, 2004

(54) Apparatus and method for cutting angled metallic studs and panels

(76) Inventor: Ronald W. Karr, Houston, TX (US)

Correspondence Address: SHERIDAN ROSS PC, 1560 BROADWAY, SUITE 1200, DENVER, CO, 80202

(21) Appl. No.: 10/265,009

(22) Filed: Oct. 3, 2002

(51) Int. Cl. B26D 1/00; B26D 3/00

(52) U.S. Cl. 83/34

(57) ABSTRACT

The present invention relates to an apparatus that cuts sheet metal, and more specifically, cut seamed sheet metal materials at user-specified angles. The present invention is capable of operation by a single person, is portable, easy to manufacture, use, adjust, and maintain, and in one embodiment utilizes a serrated blade capable of moving in a guillotine motion.

### FIELD OF THE INVENTION

The present invention relates to an apparatus that cuts sheet metal, and more specifically a portable sheet metal cutting apparatus which cuts corrugated sheet metal at a plurality of cut angles.

### BACKGROUND OF THE INVENTION

Many commercial and residential buildings and structures use sheet metal for siding, structural framing, and roofing (hereinafter “sheet metal”) because of its low expense, ease of installation, and reduced maintenance. Sheet metal is usually delivered to a construction site in long un-cut rectangular shaped sheets. The contractor then must cut at least one end to accommodate the angle of the roof, for example. This task is extremely time consuming and thus expensive depending on the shape and complexity of the wall or roof on which the siding or roofing material is being installed.

Many types of sheet metal cutters are known in the art, the most common being a sheet metal hand shear. Hand shears are rudimentary cutting devices incapable of making precision cuts and are ineffective for use with large materials. In addition, sheet metal materials often incorporate corrugations, ribs, seams, or channels (hereinafter “corrugations”) into their design to add stiffness and strength to the panel or to act as an interlocking means between two adjacent panels. The difficulty and time required to cut such materials make hand shears impractical, especially on large construction projects.

Other commercial grade sheet metal cutting apparatus are known in the art to cut sheet metal panels. These larger tools traditionally use two cutting blades, one stationary and one capable of motion. Some devices act like a hand shear, cutting from one edge of the panel to the other, and others act like a guillotine, thus cutting through an entire sheet metal panel at substantially one time. The shear cutters generally consist of a base wherein the stationary blade is integrated and a movable blade that is hinged on one end to the base and that is equipped with a handle on the opposite end. The sheet metal panel is cut by closing the handle thereby bringing the two blades together. Alternatively, the movable blade is actuated such that the entire blade comes in contact with the sheet approximately the same time, to shear the sheet metal material like a guillotine.

There are different types of movable blades, including straight and serrated. Straight blades have numerous drawbacks when used to cut corrugated sheet metal panels. First, when incorporated in a shear type apparatus, which cuts from one end to the other, the sheet material may move or deform undesirably as the blade is brought across a peak or valley of a corrugation. In a guillotine cutter, a straight blade may tend to bend the sheet before it is cut, thereby deforming the crests of the corrugations, which may force post-cutting reworks to the material which is time consuming and inherently expensive. Thus, it is common practice to use serrated edges to evenly pierce the peaks and valleys of a corrugated sheet metal panel which results in a cleaner cut.

Furthermore, sheet metal panels often are required to be cut at an angle in order to be installed. In addition, angled cutters usually require a means for holding the sheet metal panel in place while it is being cut. Unfortunately, some of the holding and cutting means are unsuitable for cutting corrugated material at an angle, because there is not enough clearance between blade pairs for a corrugated piece of sheet metal to fit. Alternatively, some cutters have sufficient clearance for certain types of corrugation shapes, but they are unsuitable for other types. Further, some stationary blades are designed to conform with the corrugation profile, but they may not be suited for other types of corrugation shapes, and thus may hinder angled cutting. In addition, some angled cutter blades are limited since they are specifically designed for use with certain corrugation shapes because their serrations are incorporated on a limited portion of the blade. Furthermore, some devices are designed to cut at a limited number of specific angles, i.e. 45 degrees. Finally, some tools may in fact be capable of cutting corrugated sheet metal panels at a multitude of angles, but adjusting from one angle to another is time consuming and may require more than one laborer.

Even though there are tools that are capable of cutting sheet metal panels at various angles, they are not capable of one-man operation. Some devices are large and require external power to perform the cutting operation, while others require two or more people to operate. In addition, larger, complex tools are more likely to malfunction and require complicated maintenance or repair.

Portability is another major concern for building contractors. The more portable a cutting apparatus, the more time and costs are saved. Some shears in use are large and impractical, while others are not portable and thus need to be delivered to a job site with a large truck. Alternatively, sheet metal panels may be cut off-site and delivered, which causes problems with respect to last minute design changes by a contractor, or incorrectly cut sheet metal panels being delivered. Ideally, sheet metal panels are cut as needed on-site to fit specific locations and minimize scrap.

Thus there is a long felt need in the field of sheet metal installation for a portable and cost effective cutting apparatus that can support and cut various types of corrugated, ribbed, seamed, and flat sheet metal material at preferred angles and that is further easy to adjust, use, and maintain.

### SUMMARY OF THE INVENTION

It is thus one aspect of the present invention to provide a portable, cost effective sheet metal cutter which can be easily adapted for use with various types of sheet metal materials. More specifically, the apparatus is adapted for cutting sheet metals employing various types of corrugation profiles, sizes, and shapes and which can be cut at an angle without time consuming adjustments to the blades.

It is another aspect of the present invention to provide a sheet metal cutting apparatus which is capable of making guillotine-type cuts that cause less deformation to the panel and are mechanically easier to perform by hand. In one embodiment, a movable blade works in conjunction with a stationary blade situated on the opposite side of the pre-cut sheet metal panel to aid the guillotine blade to perform a cleaner cut.

It is another aspect of the present invention to provide a sheet metal cutting apparatus that is equipped with a movable blade which is serrated to facilitate clean cuts on various types of sheet metal materials. In one embodiment, the movable blade consists of a single serrated blade or a plurality of smaller blades that extend over the entire cutting area that together form a serrated edge. Serrated blades are designed to pierce the peaks and valleys of corrugations evenly, thereby minimizing bending and other deformations of the panel. Alternatively, for cutting panels with seams, a serrated blade will ensure a crest of the seam is cut at the same instance the flat portion of the sheet is cut, thereby yielding a cleaner cut. In addition, serrated blades are more suited for various profiles of panels so that the blade may not have to be removed to accommodate different corrugation shapes. For example, a blade with sufficient serrations will be able to cut a widely spaced round corrugation or a narrowly spaced hat-type corrugation without a blade change, because the majority of the corrugations will be pierced in the preferred fashion. As mentioned above, in one embodiment, a stationary blade is used to aid in the cutting operation. Some prior designs have used interchangeable stationary blades that match the corrugation contour of the pre-cut sheet metal panel. Alternatively, adjustable corrugation support blocks are used to aid in the cutting operation. The use of serrated blades eliminates the requirement for these measures, and therefore adds robustness to the design, and cost savings to the cutting process.

It is yet another aspect of the present invention to provide a sheet metal cutting apparatus that is capable of holding a pre-cut sheet metal panel such that it can be cut at a multiplicity of desired angles. Prior designs of cutters were limited in the sizes and profiles of corrugations which could be cut at an angle. In one embodiment of the present invention, dies that interface with the sheet metal panel's edges and sheet metal panel guides are employed to restrain the metal panels that employ edge seams. The profile dies are selectively interconnected to die brackets and are easily adjusted or interchanged to fit various seam shapes and are capable of being used at a plurality of cut angles. The profile dies are designed so that a pre-cut panel can be set into the dies and to the desired angle before the cut is made without time consuming replacement of the dies. The combination of easily adjustable profile dies and panel guides provide the user with a multitude of cutting options while firmly securing the sheet metal panel. In addition, the relative angle between the cutting blade and the longitudinal axis of the sheet metal panel is capable of being altered between 45 to 90 degrees, where a 90 degree cut would be perpendicular to the longitudinal axis of the panel. Changes to the cut angle are made by loosening readily accessible fasteners, adjusting the panel guides and the profile dies, pivoting the cutting blade, and tightening the fasteners. Alterations to the cut angle can be completed while the panel is installed between the blades and in the guide, thereby permitting the user to more accurately set an angle without repeated removal and replacement of the sheet metal panel. Also, the profile dies can be reversed in order to cut angles between 90 to 135 degrees. This feature would be used when the panel needed to be cut to a point, such as for siding installation at a roof's apex, for example.

It is another aspect of the present invention to provide a sheet metal cutting apparatus that is portable and operable by a single person to decrease construction cost and man power needs. In one embodiment, the entire assembly is compact and light weight. The blade actuation handle is capable of supporting the entire weight of the apparatus, and maybe used as a means of transportation from one building site to another. In addition, the cutting mechanism employs rack and pinion gears that, along with the leverage provided by the blade handle, provide enough mechanical energy to the blade so the apparatus can be operated by a single user. These advantages will translate to savings to the contractor because fewer skilled laborers will be required to complete the task. Alternatively, one skilled in the art can apprieciate that the cutting operation and apparatus can easily be automated, for example with a motor that controls the blade movement.

It is yet another aspect of the present invention to provide a sheet metal cutting apparatus that is easy to maintain and repair. In one embodiment, a protective shield surrounds a blade and associated blade articulation components to provide protection to the user, prevent damage to the components, and to provide some barrier to dust and other debris. The protective shield may be removed thereby exposing the inner workings of the apparatus. Once opened maintenance activities such as inspection, fastener replacement, cleaning, lubrication, and blade replacement can be performed.

It is still yet another aspect of the present invention to provide a sheet metal panel cutting apparatus that is safe to operate and will reduce construction costs as well. In one embodiment, a handle is used to actuate the blade from its up position to its cutting position. When the blade is up, the handle is oriented on the side of the pre-cut sheet metal panel that will be used after the cut is made. The user can make the required angle and securing adjustments safely because the majority of the blade will be retracted into a protective shield. Once the panel is at the desired cutting angle and secured, the handle must be rotated substantially 180 degrees around the protective shield to the exit or scrap side of the apparatus to actuate the blade into and through the cut position. Therefore, if the user were to accidentally lean on the handle during preliminary adjustments, the blade would not be actuated and potentially cause an injury.

It is yet another aspect of the present invention to provide a sheet metal cutting apparatus that is constructed from common materials, and thus less expensive. More specifically, the majority of the components of the present invention are manufactured with steel, aluminum, or any other substantially rigid material. In addition, the majority of the components may be made of extruded material as in “L” beams, and commonly known fasteners. Basically, very few components have to be custom made, and any machining operations are minimal. Therefore, part manufacturing, replacement, and repair are inexpensive.

As can be appreciated by one skilled in the art, the present invention may be constructed in different sizes and thus may be adapted for use for any type of cutting operations. Furthermore, the protective shield can be adapted for the display of advertisements, such as the contractors name, and safety warnings.

Thus in one aspect of the present invention, a portable cutting apparatus adapted for cutting sheet metal panels at a preferred angle is provided which comprises:

a frame adapted to receive the piece of sheet metal to be cut;

an articulating handle operably interconnected to said frame;

a blade in mechanical communication with said handle and capable of reciprocating travel within said frame, wherein when said handle is in a first upward position said blade is not in contact with the sheet metal panel, and when said handle is in a second downward position said blade is in contact with the sheet metal panel; and

an adjustable holding means operably interconnected to said frame and adapted to selectively interconnect and hold the sheet of metal panel at a plurality of predetermined angles, wherein the sheet metal panel is secured such that said adjustable holding means is capable of retaining the sheet metal panel during a cutting operation to achieve a clean cut.

### BRIEF DESCRIPTION OF THE DRAWINGS

FIG. 1 is a perspective view of one embodiment of the present invention, wherein the protective shield is removed to identify the various components of the apparatus;

FIG. 2 is a front elevation view of the embodiment of the invention shown in FIG. 1;

FIG. 3 is a front elevation view of the embodiment of the present invention shown in FIG. 1, wherein the protective shield is installed and a sheet metal panel is installed in preparation of cutting;

FIG. 4 is a detail view of the embodiment of the present invention shown in FIG. 3; and more specifically depicting a sheet metal panel secured with a profile die, an entry guide, and a clamp; and

FIG. 5 is a top plan view of the embodiment of the present invention shown in FIG. 1 and depicting a sheet metal panel adapted to be cut at an angle larger than 90 degrees, wherein some components are omitted for clarity.

### DETAILED DESCRIPTION

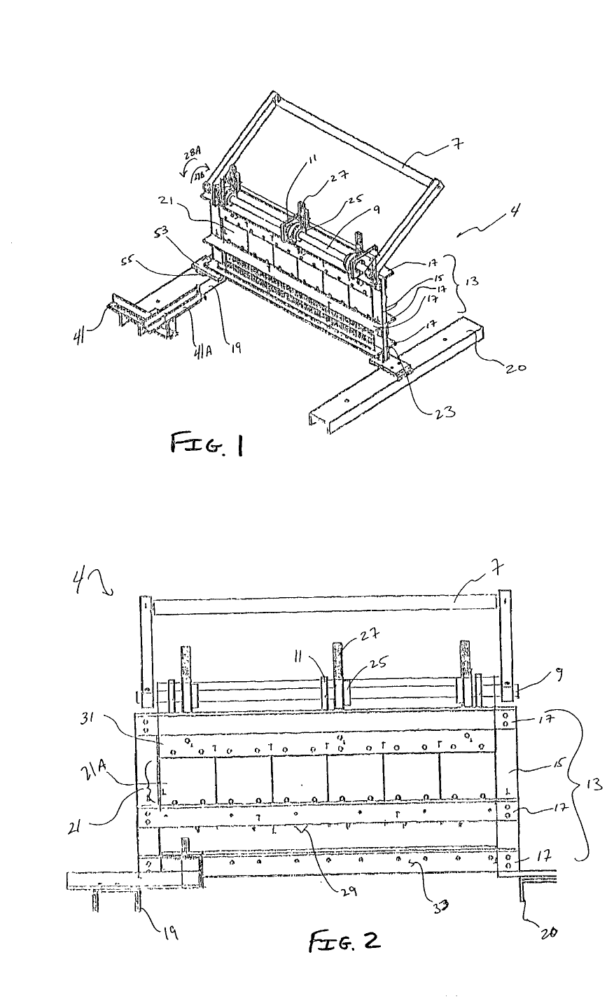

Referring now to the drawings, FIGS. 1-5 depict an apparatus for cutting sheet metal panels, and which can be safely performed by one person. More specifically, in one embodiment of the present invention the apparatus is adapted to cut exterior siding seamed sheet metal panels at various angles by sliding the sheet metal panels through the apparatus under a movable blade. A plurality of fasteners and clamps, along with channels and guides that approximately match the profile of the panel's seams, hold the panel securely in place. Preferably, the channels are rotatable around a point which allow a user to set the sheet metal panel to a desired angle prior to cutting.

Referring now to FIG. 1, one embodiment of the present invention is depicted with a protective shield removed for clarity. The angled cutting shear 4 functions generally by articulating a handle 7 that is interconnected to a shaft 9. The shaft 9 is interconnected by bearings 11 to a frame 13, which further includes a plurality of vertical members 15 and horizontal members 17 operably interconnected to a moveable base channel 19, and interconnected to a fixed base channel 20. A blade 21 rides in a channel 23 and is interconnected to the shaft via a pinion 25 and rack gear 27 system, such that the blade 21 can freely travel and reciprocate in a vertical direction between the frame members without interference when the handle 7 is actuated. Preferably, in one embodiment the vertical members 15 and the horizontal members 17 are constructed from steel, aluminum, or any other rigid material as appreciated by one skilled in the art. Further, the horizontal members 17 may be constructed from “L” beams and interconnected to the vertical members with bolts, welds, or other interconnecting methods. Also, the channel 23 between the frame 13 members is sufficiently spaced such that the blade 21 can travel freely yet not be constrained to affect the precision of a cut. In operation, the user articulates the blade 21 by starting with the handle 7 in the “blade up” position 28A and transitioning the handle through to the “shear” position 28B. This motion effectively drives the blade 21 downward through the sheet metal panel or other material.

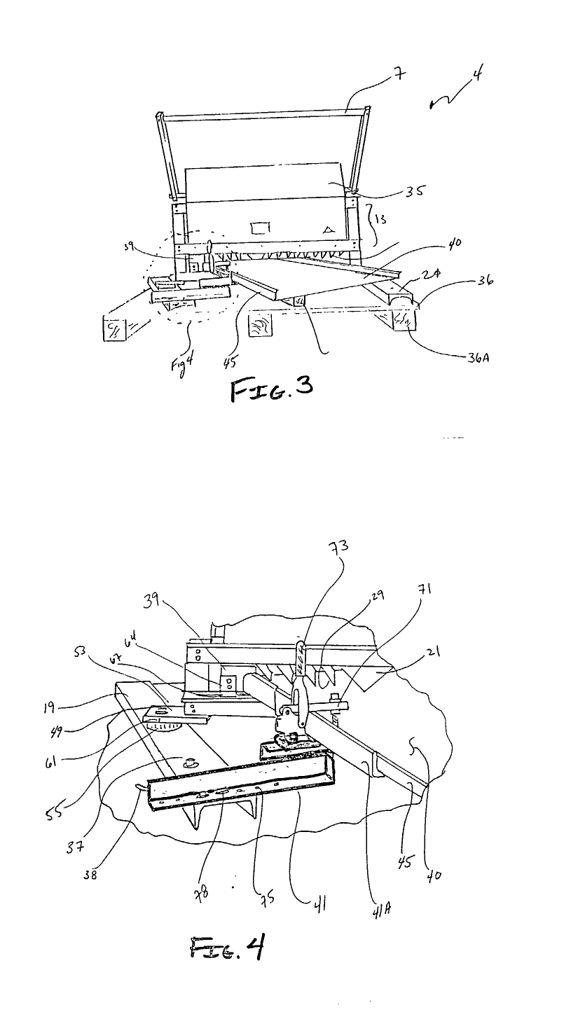

Referring now to FIG. 2, a front plan view of one embodiment of the present invention is shown with the protective shield removed for clarity. More specifically, the blade 21 is shown in greater detail. Preferably, the blade 21 is constructed from a plurality of smaller blade segments 21A. Alternatively, the blade 21 may be constructed from a single piece of material. The blade segments 21A, which include edges 29, interface with a common blade plate 31 that is in turn interconnected to the rack gears 27. In this embodiment, individual blade segments 21A can be replaced easily without replacing the entire blade. In addition, a user may tailor the type and size of the blade segments 21A for custom tasks. It should be noted, as in other guillotine metal cutters known in the art, the apparatus contains stationary blades 33 which straddle the articulating blade 21 and which are interconnected to a lower horizontal member 17 of the frame 13. The stationary blades 33 perform an opposite cutting motion when the handle 7 is transitioned and the articulating blade 21 is forced down on the sheet metal panel so that both sides are cut concurrently to prevent deformation.

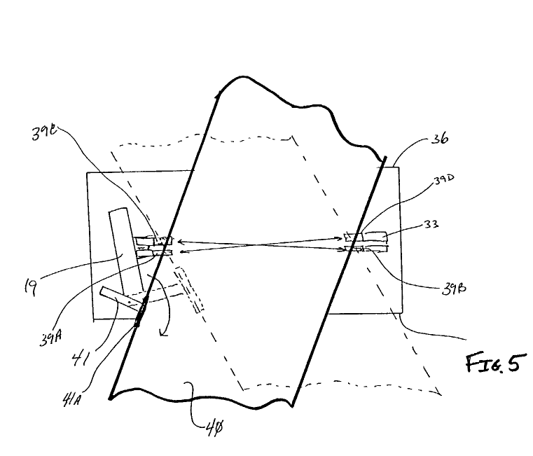

Referring now to FIGS. 3 and 4, a front elevation and front perspective view of one embodiment of the present invention is shown with the protective shield 35, base members, and the sheet metal panel 40 in place to be cut at an angle. Once at the work site, the angle shear's 4 base channels 19 and 20 are preferably mounted to a base 36, which may include riser blocks 36A. The base and riser blocks are preferably constructed of wood, but other rigid materials may also be employed. It should be noted that at least one of the base interface bolts 37 is adapted to ride in an adjustment slot 38 to provide rotational freedom during initial adjustments.

In operation, the handle 7 is moved to the front entry side of the apparatus (see FIG. 1, item 28A) to provide a gap into which the sheet metal panel will be inserted. Setting the angle shear 4 to cut the sheet metal panel 40 of a particular profile to a specific angle may require adjustment of a base channel 19, profile dies 39, and an entry guide 41. Initially, the correct profile die 39 must be selected that generally matches the profile of the seam 45. Various profile dies 39 can be used, and in one embodiment, at least two unique profile dies are used. When installed, the panel's 40 seam 45 is seated in the panel interface portion 41A of the entry guide 41.

Initially, to set a desired cutting angle, a pivot point 49 of the base channel 19 may require adjustment. The frame 13 is connected to a foot plate 53 which in turn is operably interconnected to an angle degree wheel 55 which is interconnected to the base channel 19 through the pivot point 49. The relative angle of the frame 13 and the panel 40 is set by loosening the pivot fastener 49 and rotating the base channel 19 until the desired angle is achieved. The user may use an indication mark 61 that lines up with a plurality of incremental hash marks on the angle degree wheel 55 to accurately set the desired angle. As noted above, at least one bolt 37 that interfaces with the base 36 rides in a slot 38 that in turn allows the base channel 19 to rotate about the pivot point 49.

Subsequently, the profile dies 39 (which function as sheet metal panel securing means) are adjusted in relation to the shear blade edges 29. Initially, the fasteners that hold a profile die bracket 64 need to be loosened in order for the bracket 64 to travel in a profile die track 67. The panel 40 is then fed along the entry guide 41A through the profile dies 39 until the cut plane is at the desired location on the panel 40. A clamp 71that interfaces with the panel 40 and holds it firmly against the entry guide 41A is then engaged, in one embodiment, by a clamp handle 73. Preferably, the profile die brackets 64 are adjusted such that the blade 21 points are positioned just inside a panel seam 45 before blade engagement. For example, for a “C” channel type seam profile, the distance between the nearest blade 21 point and the upper portion of the seam is preferably about 0.50 inches. This length can be verified by carefully actuating the handle 7 towards the shear position (see FIG. 1, item 28B) but not far enough to actually contact the panel 40. In order to make the required adjustments, the entry guide 41 is equipped with a plurality of holes 75 and fasteners 78, or other operably interconnection mechanisms that allow the entry guide 41 to move relative to the base channel 19 as the panel is angulated. Finally, after the desired cut angle is set, the profile dies 39 preferably are moved to fit snugly against the seams 45 and all the adjustment fasteners tightened or locked.

Referring now to FIG. 5, an alternative embodiment of the present invention is provided which is adapted to cut opposite angles of the panel 40. More specifically, FIG. 5 depicts the adjustments to the profile dies 39 that may be required in order to cut opposite angles. For example, some applications may require the user to cut the panel 40 at opposite angles. More specifically, the panel 40 must be cut to a “point”, wherein a tip is provided between the edges of the panel 40 and not on the seams 45. Alternatively, the panel 40 may be cut wherein the point is on the opposite seam 45. To perform this operation, it is necessary to make some modifications to the apparatus. More specifically, since the profile dies 39 are tailored to allow cutting angles from 0 to 90 degrees, the profile dies 39 must be altered to cut angles from 90 to 135 degrees. Before the panel 40 is inserted, the left front profile die 39A is switched with the right rear profile die 39D and the right front profile die 39B is switched with the left rear profile die 39C. Next, the above-described steps are performed, except prior to tightening the fasteners, the entry guide 41 is rotated in the opposite direction to achieve opposite angled cuts. Alternatively, as can be appreciated by one skilled in the art, and depending on the seam shape, an opposite angle cut may be achieved by altering the profile dies, flipping the panel 40, and cutting to achieve the desired resultant cut shape.

Referring now to all the previously discussed figures, the cutting guillotine operation on the panel is generally described herein. The handle 7 is articulated from the entry side or “blade up” location 28A of the angle shear 4 to the exit side or “shear” position 28B. During articulation, the blade 21 will emerge from the protective shield 35, initially pierce the panel 40, and then shear with the blade edges 29, all while the stationary blade 33 is shearing from the opposite direction. The handle 7 is then articulated back to its starting position, thereby retracting the blade 21 to a safe position for subsequent adjustments and cuts.

To assist in the understanding of the present invention the following list of components and associated numbering found in the drawings is provided herein:

# Component

4 Angle shear

7 Blade actuating handle

9 Shaft

11 Bearings

13 Frame

15 Vertical frame member

17 Horizontal frame member

19 Movable base channel

20 Stationary base channel

21 Articulating blade

21A Blade segment

23 Blade channel

25 Pinion gear

27 Rack gear

28A “Blade up” direction

28B “Shear” position

29 Shear blade edge

31 Blade interface plate

33 Stationary blades

35 Protective shield

36 Base

36A Base riser block

37 Bolt

38 Base channel adjustment slot

39 Profile die

39A Left front profile die

39B Right front profile die

39C Left rear profile die

39D Right rear profile die

40 Sheet metal panel

41 Entry guide

41A Panel interface of entry guide

45 Panel seam

49 Base channel pivot point

53 Base channel foot plate

55 Degree wheel

61 Degree indication mark

64 Profile die bracket

67 Profile die bracket track

71 Holding clamp

73 Holding clamp handle

75 Entry guide adjustment holes

78 Entry guide adjustment fasteners.

While various embodiments of the present invention have been described in detail, it is apparent that modifications and abdications of those embodiments will occur to those skilled in the art. However, it is to be expressly understood that such modifications and abdications are within the scope and spirit of the present invention, as set forth in the following claims.

What is claimed is:

1. A portable cutting apparatus adapted for cutting sheet metal panels at a preferred angle, comprising:
a frame adapted to receive the piece of sheet metal to be cut;
an articulating handle operably interconnected to said frame;
a blade in mechanical communication with said handle and capable of reciprocating travel within said frame, wherein when said handle is in a first upward position said blade is not in contact with the sheet metal panel, and when said handle is in a second downward position said blade is in contact with the sheet metal panel; and
an adjustable holding means operably interconnected to said frame and adapted to selectively interconnect and hold the sheet of metal panel at a plurality of predetermined angles, wherein the sheet metal panel is secured such that said adjustable holding means is capable of retaining the sheet metal panel during a cutting operation to achieve a clean cut.

2. The apparatus of claim 1, wherein said adjustable holding means comprises:
at least one entry guide adapted for interconnection to an edge of the sheet metal panel; and
at least one holding clamp interconnected to said entry guide and adapted for securing the sheet metal panel to said entry guide.

3. The apparatus of claim 1, wherein said blade and said adjustable holding means are adapted for use with sheet metal panels that employ seams, ribs, or corrugations.

4. The apparatus of claim 3, further comprising:
at least one profile die which is adapted for selective interconnection to said frame and the sheet metal panel, wherein said profile die is capable of allowing the sheet metal panel to be installed under said blade in said frame at a predetermined cutting angle.

5. The apparatus of claim 1, wherein said blade is serrated.

6. The apparatus of claim 1, wherein said blade includes a plurality of removable blade segments.

7. The apparatus of claim 1, further comprising a protective shield selectively interconnected to said frame, wherein said blade is substantially enclosed when said handle is in said first upward position.

8. The apparatus of claim 1, wherein said frame is interconnected to at least one stationary base channel and operably interconnected to at least one movable base channel, wherein said adjustable holding means is capable of being moved to a plurality of cutting positions.

9. The apparatus of claim 1, further comprising:
a shaft interconnected to said handle and operably interconnected to said frame;
at least one pinion gear interconnected to said shaft;
at least one rack gear which is in mechanical communication with said blade and which is in mechanical communication with said pinion gear, wherein articulation of said handle from said first upward position to said second downward position rotates said shaft and pinion gear to impart motion on said rack gear and said blade to cut the sheet metal panel.

10. The apparatus of claim 1, wherein said frame, blade, and adjustable holding means are further capable of cutting pipes or beams at a predetermined angle.

11. A portable cutting apparatus adapted for cutting sheet metal panels at a plurality of angles, comprising:
a frame adapted to receive the piece of sheet metal to be cut, and which further includes a stationary blade integrated onto a horizontal frame member;
a shaft operably interconnected to said frame;
an articulating handle interconnected to said shaft;
at least one pinion gear interconnected to said shaft;
at least one rack gear in mechanical communication with said pinion gear;
a blade plate interconnected to said rack gear;
a blade selectively interconnected to said blade plate and capable of reciprocating travel within said frame, wherein when said handle is in a first upward position said blade is not in contact with the sheet metal panel, and when said handle is articulated to a second downward position to initiate a cutting operation;
at least one adjustable entry guide operably interconnected to said frame which is adapted to secure the sheet metal panel under said blade segments at a plurality of angles; and
at least one holding clamp interconnected to said entry guide and adapted to selectively secure the sheet metal panel, wherein the sheet metal panel is retained in a substantially stationary position during the cutting operation.

12. The apparatus of claim 11, wherein said blade and said adjustable entry guide are adapted to be used with sheet metal panels that employ seams, ribs, or corrugations.

13. The apparatus of claim 11, wherein said blade is comprised of a plurality of blade segments.

14. The apparatus of claim 11, further comprising a protective shield selectively interconnected to said frame, wherein said blade is substantially shrouded from a user when said handle is in said first upward position.

15. The apparatus of claim 11, wherein said frame is interconnected to at least one stationary base channel and operably interconnected to at least one movable base channel, wherein said adjustable entry guide may be positioned in a plurality of cutting positions.

16. The apparatus of claim 1, wherein said portable cutting apparatus is capable of cutting a pipe or a beam at a predetermined angle.

17. The apparatus of claim 11, further comprising: at least one profile die operably interconnected to said frame, which is adapted for interconnection to a sheet metal panel which employs at least one edge seam, wherein said profile die is capable of allowing the sheet metal panel to be securely positioned under said blade at a desired cutting angle prior to cutting.

18. A method of cutting sheet metal panels at a predetermined angle, comprising the steps of:
setting a cut angle by adjusting a movable base channel of an angled cutting apparatus;
selecting the proper profile die that substantially matches the shape of an edge seam on said sheet metal panel;
sliding said sheet metal panel under a blade of said cutting apparatus;
interconnecting said profile die to said cutting apparatus and said sheet metal panel to secure said sheet metal panel in a substantially static position;
applying a force to a handle of said cutting apparatus, wherein the force moves the blade downward and cuts said sheet metal panel at the predetermined angle.

19. The method of claim 18, wherein said setting of said cut angle comprises:
loosening a rotation bolt connected to said movable base channel;
rotating said movable base channel to the predetermined location;
tightening said rotation bolt; and
adjusting an edge guide of said cutting apparatus which is operably interconnected to said movable base channel, wherein the sheet metal panel will be at the proper predetermine cutting angle when installed.

20. The method of claim 18, wherein the securing step comprises:
placing the edge sheet metal panel on a guide of the apparatus which has been set to a predetermined cutting angle;
sliding the sheet metal panel along said guide and under said blade and through said profile die so that a predetermined post-cutting length will be obtained;
securing the sheet metal panel onto said guide; and
securing said profile die to a frame of said cutting apparatus.

21. The method of claim 18, wherein said handle is interconnected to a shaft which includes at least one pinion gear which is in mechanical communication with at least one rack gear that is interconnected to said blade.

22. The method of claim 18, wherein said blade is comprised of a plurality of individual segments.

23. A portable cutting apparatus adapted for cutting sheet metal panels, comprising:
a frame adapted to receive the sheet metal panel;
a motor interconnected to said frame;
a blade in mechanical communication with said motor and capable of reciprocating vertical travel within said frame, wherein said motor can be controlled to articulate said blade from a first upward position to a second downward position, wherein as the said blade articulates the sheet metal panel is cut;
an adjustable holding means operably interconnected to said frame and adapted to selectively interconnect and hold the sheet of metal panel at a plurality of predetermined angles, wherein the sheet metal panel is secured such that said adjustable holding means are capable of retaining the sheet metal panel during the cutting operation to achieve a clean cut.
